(19) United States
(12) Patent Application Publication
(10) Pub. No.: US 2006/0288347 A1
(43) Pub. Date: Dec. 21, 2006

(54) Exploiting entity relationships in proximity-based scheduling applications

(75) Inventors: Daniel Everett Jemiolo, Morrisville, NC (US); Balan Subramanian, Morrisville, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/156,783

(22) Filed: Jun. 20, 2005

(51) Int. Cl. G06F 9/46

(52) U.S. Cl. 718/102

(57) ABSTRACT

Entity relationships are created, discovered, and applied in proximity-based scheduling applications. When a signal is received from an entity in proximity to a user of a data processing system, the signal is compared against previously recorded signals. If a signal match is found, the entity generating the signal is identified using the entity definition associated with the previously recorded signal. Entities associated with the entity generating the signal are also identified. A reminder is provided to the user to perform tasks associated with the entity and tasks associated with the others entities while the user is in proximity to the entity. If a signal match is not found, and if the user has performed a task with an unassociated entity, a relationship may be created between the entity associated with the performed task and the unassociated entity, either automatically or upon prompting the user.

### BACKGROUND OF THE INVENTION

The present invention relates to information processing systems, and in particular, to user information management systems. Still more particularly, the present invention relates to exploiting entity relationships in proximity-based scheduling applications.

Computing devices take many different forms. Computing devices may be, for example, a workstation, a laptop, a personal digital assistant (PDA), and a digital or mobile phone. Larger devices, such as workstations and personal computers provide large amounts of storage and computing power. Smaller computing devices, such as a PDA or mobile phone, do not have as much processing power or storage. These types of devices, however, provide portability and convenience for the user.

With portable computing devices, a user is able to carry information, such as addresses and appointments on these devices to allow for easy access to this type of information. Some of these small, mobile, electronic devices incorporate so-called personal information manager (PIM) software, such as a calendar for scheduling events or a to-do list application. A user may create events that are stored for later review. Further, with an event, a reminder option may be created for this event. This reminder option may cause the calendar program to present a pop-up dialog in the user device at a predetermined time prior to the event to remind the user of the upcoming event. Examples of personal information management software include IBM® Lotus® Notes® software and Microsoft® Outlook® software (IBM, Lotus and Notes are trademarks of International Business Machines Corporation in the United States, other countries, or both while Microsoft and Office are trademarks of Microsoft Corporation in the United States, other countries, or both).

To understand the different ways to-do lists are processed, consider the following examples:
1. A manager schedules a status meeting at 4:30 p.m. on December 31^{st}, and expects the meeting to occur at that exact date and time, unless notified of a reschedule.
2. A programmer wants to pitch a new invention to a teammate the next time they meet face-to-face, such as at lunch or in the break room.
3. A teenager wants to buy the latest music CD the next time at the local store.
4. A college student buys an economy-sized tub of pretzels every time he is at the warehouse club.
5. A new homeowner wants to shop for lamps at a particular store's half-off sale (now through Christmas) the next time near the local mall.

In the first example, scheduling is done by time, and fits with the calendar model of existing personal information management applications. The second example is based on convenience. The third and fourth examples are based on location and convenience, with no specific time required. The last example is a flexible combination of time, location, and convenience. Thus, as shown by the examples above, many of the tasks users create for themselves do not fit nicely into the time/date restrictions of today's personal information management applications.

### BRIEF SUMMARY OF THE INVENTION

The present invention provides for exploiting entity relationships in proximity-based scheduling applications. When a signal is received from an entity in proximity to a user of a data processing system, the signal is compared against a plurality of previously recorded signals. If a signal match is found, the entity definition associated with the previously recorded signal is used to identify the entity that generated the incoming signal. In addition, entities associated with the entity generating the signal are also identified. A reminder may then be provided to the user to perform tasks associated with the entity and tasks associated with the other entities while the user is in proximity to the entity.

### BRIEF DESCRIPTION OF THE SEVERAL VIEWS OF THE DRAWINGS

FIG. 1 depicts a pictorial representation of a distributed data processing system in which aspects of the present invention may be implemented;

FIG. 2 is a block diagram depicting a data processing system that may be implemented as a server in accordance with the embodiments of the present invention;

FIG. 3 is a block diagram illustrating a data processing system that may be implemented as a client in accordance with embodiments of the present invention;

FIG. 4 is a block diagram depicting an overall view of a computing system for creating, discovering, and applying entity relationships in accordance with an embodiment of the present invention;

FIG. 5 is a diagram of an exemplary computing device in the form of a personal digital assistant (PDA) in accordance with an embodiment of the present invention;

FIG. 6 is a block diagram of a PDA in accordance with an embodiment of the present invention;

FIGS. 7A-C illustrates example entity relationships in accordance with an embodiment of the present invention; and

FIG. 8 is a flowchart of a process for creating, discovering, and reporting reminders using entity relationships in accordance with an embodiment of the present invention.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer useable or readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The different aspects of the present invention provide a method and system for bridging the gap between the capabilities of existing scheduling applications, such as Lotus Notes and Microsoft Outlook programs, and user's mental To-Do lists. A user's mental to-do list may comprise various tasks to be performed based on proximity and convenience to entities that provide services the user seeks. For example, consider the following scenarios. If a user checks out a Christmas sale on TVs at a local store, the user probably would want to look at TVs when the user is at a related department store as well, since both entities are owned by the same company and have similar prices/sales. It would be beneficial if a task scheduler could associate the two entities. Likewise, a user who makes a note in a scheduler to pick up milk at a convenience store on the way home may not care whether the convenience store is Gas Station A on Main Street or Gas Station B on State Hwy. 1—the user just knows that the user has to stop at a convenience store. Furthermore, users who set out to buy cleaning supplies at Store A and end up buying them at Store B should expect their calendar to suggest Store B as a place to pick up cleaning supplies the next time the task is created in the scheduler.

The examples above demonstrate how dynamic a user's mental calendar can be. The present invention addresses this issue by providing a mechanism, built on a basic entity-to-task mapping system, which allows for the creation, discovery, and application of entity relationships in a proximity-based task scheduler. These entity relationships are used to create calendaring applications that accurately portray the fluidity of the user's mental task scheduling. The entity relationships provide a proximity-based task scheduler with the ability to model the “convenience” aspect of scheduling. In this manner, the task scheduler allows a user to create direct entity relationships (such as between related stores), reminds a user to perform a task when the user device is in proximity to an entity associated with the task (such as purchasing milk at Gas station A), and executes the task for all related entities (such as Gas station B), and provides suggestions and creates entity relationships when a task associated with a particular entity is completed without the presence of the entity (such as creating a relationship between stores that sell the same or similar products when the user purchases cleaning supplies at Store A instead of Store B).

According to one aspect of the present invention, enhanced personal information management software and sense-and-respond technology are provided within a user's mobile computing device. The enhanced personal information management software allows users to create tasks (to-do items) and associate each task with one or more entities. An entity may be a person, place, or an object. The collection of known entities may be created on the fly (as the user device encounters new entities) by user input or from a global database. The user may refine the relationships between entities so that the entities fit the user's mental model. The personal information management software may also use the refined relationships to make suggestions to the user. For example, if a user sets a reminder to change the address on the user driver's license at the Department of Motor Vehicles (DMV), the user computing device may suggest the task be executed when the user walks by one of the small DMV Driver's License bureaus in a local shopping plaza. The ability to create relationships/hierarchies between places and things in this manner means that a task is not restricted to being “time-based”, “location-based”, etc. Rather, the present invention allows for using a combination of factors that more closely resembles the fluidity of human memory.

Sense-and-respond technology may be used by the user's mobile computing device to discover entities. Sense-and-respond technology may comprise any technology where a signal is transmitted by a client, received by another component, and used to identify the client and/or take action based on the reception. Examples of sense-and-respond technology include, but are not limited to, radio frequency identification (RFID) and Bluetooth® Wireless Technology. RFID is a generic term for wireless technologies that use radio waves to automatically identify people or objects. In particular, RFID employs tags, or transponders, which store information to be transmitted wirelessly in an automated fashion to specialized RFID readers, or interrogators. There are several methods of identification, but the most common is to store a “serial-number” that identifies a person or object, and perhaps other information, within a tag comprising a microchip that is attached to an antenna. The “serial number” may be used to specify the unique, numerical identifier of the entity, thereby allowing a user device to distinguish one entity from another. For example, when an entity transmits a signal comprising its unique identifier and other information, an RFID-enabled mobile computing device may receive the signal and identify the entity.

The mobile computing device constantly polls the area surrounding the device to locate entities using the sense and respond technology. When a signal is detected, the personal information management software compares the incoming signal to previously recorded signals and their associated entity definitions. When an entity definition matching the incoming signal is found, the personal information management software executes the tasks associated with that definition. For example, a task execution may be represented by the computing device reminding the user, upon walking into a particular store, that the user needs to buy an economy-sized tub of pretzels, or reminding the user that the oil needs to be changed when the user gets into the user's car.

If the incoming signal does not match a previously recorded signal, a determination is made as to whether the user has performed a task with an unassociated entity. If so, according to another aspect of the present invention it may be suggested to the user that an entity relationship be created between the entity associated with the performed task and the unassociated entity. Alternatively, a relationship may be automatically created between the entity associated with the performed task and the unassociated entity. This learned relationship may subsequently be used in the future to provide scheduling reminders to the user.

As a user may make changes to the list of entities stored on the user's portable computing device, the user may synchronize the device with entity information stored in a centralized database. This synchronization also allows entity updates present in the centralized database to be provided to the mobile computing device. In this manner, a user may have an up-to-date database of entity information on the user's portable device.

In addition, relationships created by different users may also provide feedback from the users to the centralized database. For example, many users may determine that over time, tasks that they perform at Store A may be performed at Store B as well. As the users individually create a relationship between Stores A and B for one or more tasks, the centralized database may be updated to reflect these relationships. These relationships may be synchronized back to the centralized database based on a threshold. For instance, inclusion in the centralized database may be based on both the number of users who have created the same relationship and the number of tasks for which the users discovered this relationship.

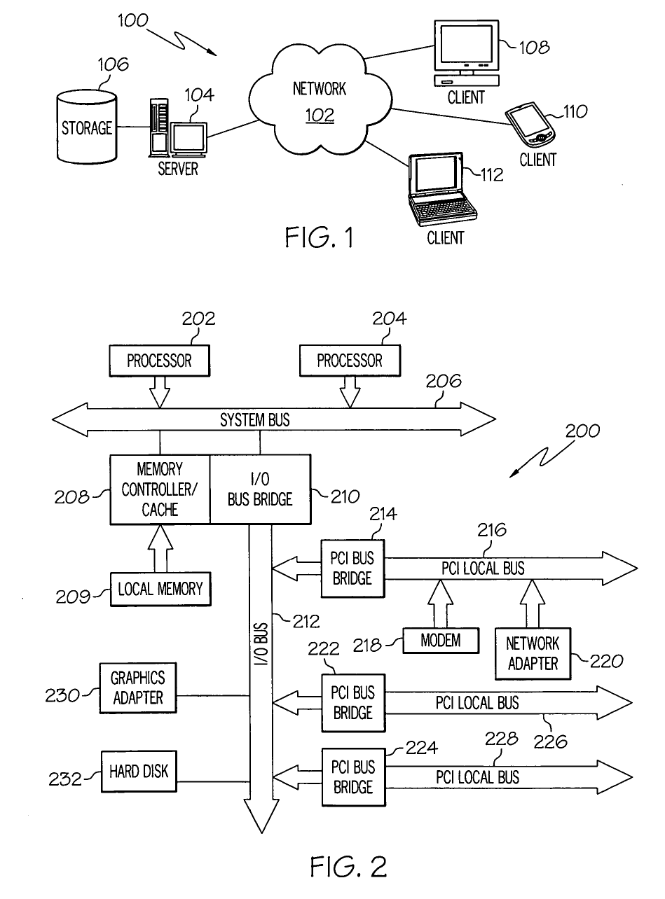

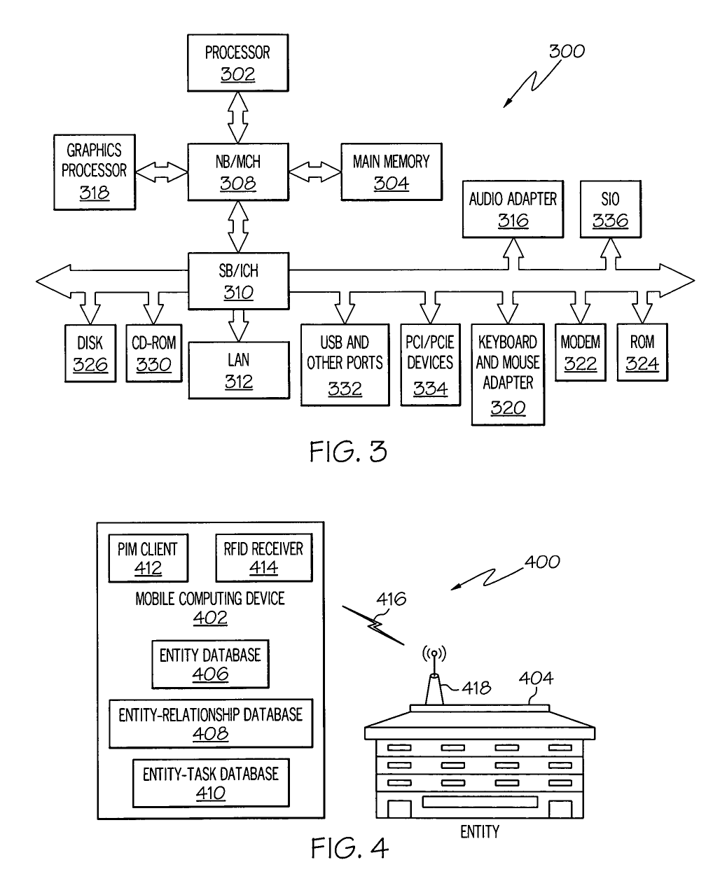

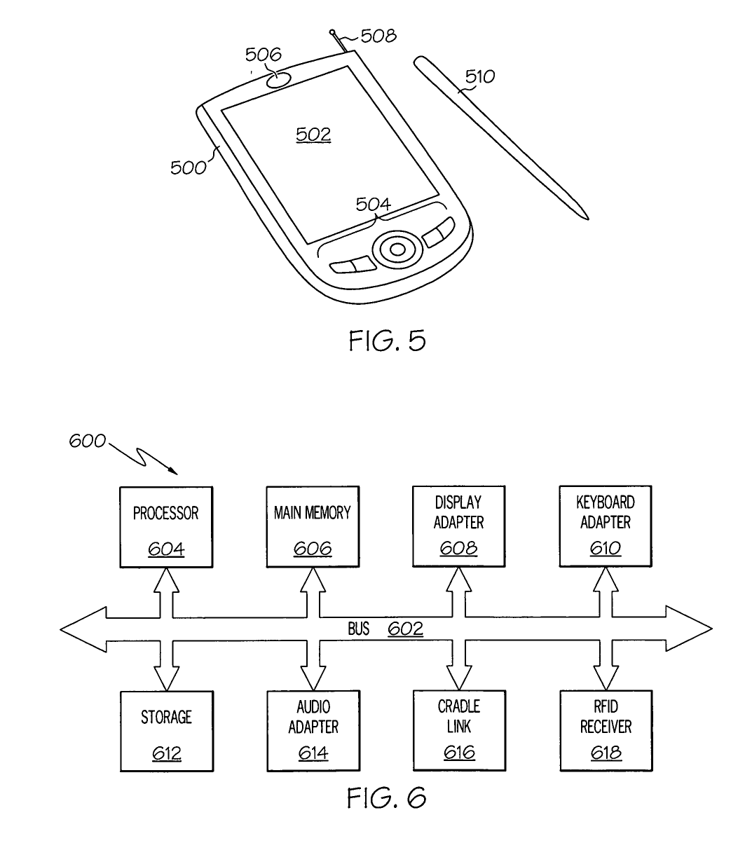

The user mobile computing device may act as a client in a networked data processing system in a manner similar to client 108 depicted in FIG. 1 or data processing system 300 in FIG. 3. Entity information contained in the user mobile computing device may be synchronized with entity information stored in a centralized database, which may be accessed by a data processing system, such as server 104 in FIG. 1 and server 200 in FIG. 2. In an alternative embodiment, the user mobile computing device may access the centralized database directly. FIGS. 1-3 are discussed in more detail below. After locating an entity using a computing system, such as that shown in FIG. 4, the user mobile computing device may execute tasks associated with that entity. An example of a user mobile computing device for receiving entity information in the form of a PDA is described further in FIGS. 5 and 6.

FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 connects to network 102 along with database 106. In addition, clients 108, 110, and 112 connect to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In accordance with an illustrative aspect of the present invention, server 104 provides application integration tools to application developers for applications that are used on clients 108, 110, and 112. More particularly, server 104 may provide access to application integration tools that will allow two different front-end applications in two different formats to disseminate messages sent from each other.

In accordance with one illustrative aspect of the present invention, a dynamic framework is provided for using a graphical user interface (GUI) for creating and editing message formats. This framework involves the development of user interface (UI) components for message data elements in the visualization and building of message formats, which may exist in database 106. This framework may be provided through an editor mechanism on server 104 in the depicted example. The UI components and message data elements may be accessed, for example, using a browser client application on one of clients 108, 110, 112.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as, for example, an intranet, a local area network (LAN), or a wide area network (WAN).

FIG. 1 is intended as an example, and not as an architectural limitation for the present invention. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

Referring to FIG. 2, a block diagram of a data processing system that may be implemented as a server, such as server 104 in FIG. 1, is depicted in accordance with an aspect of the present invention. Data processing system 200 may be a symmetric multiprocessor (SMP) system including a plurality of processors 202 and 204 that connect to system bus 206. Alternatively, a single processor system may be employed. Also connected to system bus 206 is memory controller/cache 208, which provides an interface to local memory 209. I/O bus bridge 210 connects to system bus 206 and provides an interface to I/O bus 212. Memory controller/cache 208 and I/O bus bridge 210 may be integrated as depicted.

Peripheral component interconnect (PCI) bus bridge 214 connects to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® computer system, running the Advanced Interactive Executive (AIX®) operating system or LINUX operating system (eServer, pseries and AIX are trademarks of International Business Machines Corporation in the United States, other countries, or both while Linux is a trademark of Linus Torvalds in the United States, other countries, or both).

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 connect to ICH 310. PCI/PCIe devices may include, for example, Ethernet adapters, add-in cards, PC cards for notebook computers, etc. PCI uses a card bus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and coordinates and provides control of various components within data processing system 300 in FIG. 3. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 300 (Java is a trademark of Sun Microsystems, Inc. in the United States, other countries, or both).

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the present invention may be applied to a multiprocessor data processing system.

In some illustrative examples, data processing system 300 may be a personal digital assistant (PDA), which is configured with flash memory to provide non-volatile memory for storing operating system files and/or user-generated data. A bus system may be comprised of one or more buses, such as system bus 206, I/O bus 212 and PCI buses 216, 226 and 228 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 218 or network adapter 220 of FIG. 2 or modem 322 or LAN 312 of FIG. 3. A memory may be, for example, local memory 209 or cache such as found in memory controller/cache 208 of FIG. 2 or main memory 304 of FIG. 3. A processing unit may include one or more processors or CPUs, such as processor 202 or processor 204 of FIG. 2 or processor 302 of FIG. 3. The depicted examples in FIGS. 1-3 and above-described examples are not meant to imply architectural limitations. For example, data processing system 300 also may be a tablet computer, laptop computer, or telephone device in addition to taking the form of a PDA.

FIG. 4 is a block diagram depicting an overall view of a computing system for creating, discovering, and applying entity relationships in accordance with an embodiment of the present invention. In this illustrative example, computing system 400 comprises sense-and-respond enabled mobile computing device 402 and entity 404. Mobile computing device 402 comprises entity database 406, entity-relationship database 408 and entity-task database 410, personal information management client 412, and receiver 414. Entity database 406 comprises a union of entity information from a private entity collection (e.g., the mobile computing device) and a global database of public entities (e.g., database 106 in FIG. 1). Entity-relationship database 408 comprises a set of equality and inclusion relationships between known entities in entity database 406. Entity-task database 410 comprises a set of entity-task relationships, where each entity may map to N tasks.

Personal information management client 412 is the software component in mobile computing device 402 which implements a task scheduler. Antenna unit 418 on entity 404 provides a communications link 416 to mobile computing device 402. Communications link 416 may be a radio frequency communications link generated between antenna unit 418 and receiver unit 414 located on mobile computing device 402. A transmission unit in entity 404 connected to antenna unit 418 transmits a signal comprising a unique identifier to mobile computing device 402. Receiver unit 414, such as an RFID sensor, polls the surrounding area for transmitted entity signals. When a signal is detected, personal information management client 412 compares the incoming signal with signals in entity database 406. When a match is found and the entity identified, personal information management client 412 queries entity-task database 410 to obtain all of the tasks associated with the identified entity. Personal information management client 412 then executes the tasks associated with the entity. For instance, personal information management client 412 may provide a reminder to the user of the tasks to be performed while in proximity to the detected entity. This reminder may be provided to the user in a visual or audible manner.

If the user performs a scheduled task, but the task was performed in the presence of an entity not associated with the task, personal information management client 412 may suggest to the user that a relationship between the task and the unrelated entity be created. In addition, personal information management client 412 may suggest that a relationship between the new entity and entities already associated with the task be created. Alternatively, personal information management client 412 may automatically update entity-relationship database 408 and entity-task database 410 without prompting the user.

FIG. 5 is a diagram of an exemplary mobile computing device in the form of a personal digital assistant (PDA) in accordance with an embodiment of the present invention. Although the hardware platform of the present invention is described in terms of a PDA, it should be noted that other mobile computing devices, such as a laptop computer or a cell phone, may also be used.

PDA 500 includes a display 502 for presenting textual and graphical information. Display 502 may be a known display device, such as a liquid crystal display (LCD) device. The display may be used to present a map or directions, calendar information, a telephone directory, or an electronic mail message. In these examples, screen 502 may receive user input using an input device such as, for example, stylus 510.

PDA 500 may also include keypad 504, speaker 506, and antenna 508. Keypad 504 may be used to receive user input in addition to using screen 502. Speaker 506 provides a mechanism for audio output, such as presentation of an audio file. Antenna 508 provides a mechanism used in establishing a wireless communications link between PDA 500 and an entity, such as communication link 416 in FIG. 4.

PDA 500 may also include a graphical user interface that may be implemented by means of systems software residing in computer readable media in operation within PDA 500.

Turning now to FIG. 6, a block diagram of a PDA is shown in accordance with an embodiment of the present invention. PDA 600 is an example of a PDA, such as PDA 500 in FIG. 5, in which code or instructions implementing the processes of the present invention may be located. In this illustrative example, PDA 600 includes a bus 602 to which processor 604 and main memory 606 are connected. Display adapter 608, keypad adapter 610, storage 612, audio adapter 614, and receiver 616 also are connected to bus 602. Cradle link 616 provides a mechanism to connect PDA 600 to a cradle used in synchronizing private entity data in PDA 600 with entity data in a global database, such as global database 106 in FIG. 1. Further, display adapter 608 also includes a mechanism to receive user input from a stylus when a touch screen display is employed.

An operating system runs on processor 604 and is used to coordinate and provide control of various components within PDA 600 in FIG. 6. The operating system may be, for example, a commercially available operating system such as Windows CE, which is available from Microsoft Corporation. Instructions for the operating system and applications or programs are located on storage devices, such as storage 612, and may be loaded into main memory 606 for execution by processor 604.

Those of ordinary skill in the art will appreciate that the hardware in FIG. 6 may vary depending on the implementation. Other internal hardware or peripheral devices, such as flash ROM (or equivalent nonvolatile memory) or optical disk drives and the like, may be used in addition to or in place of the hardware depicted in FIG. 6.

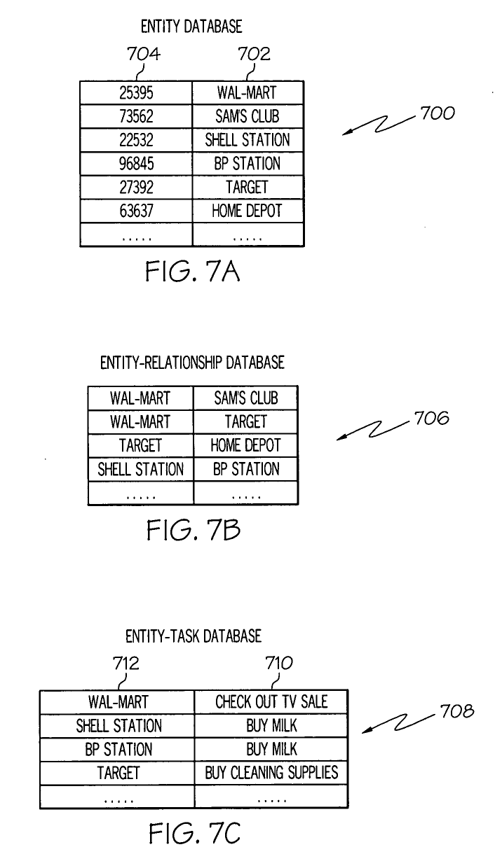

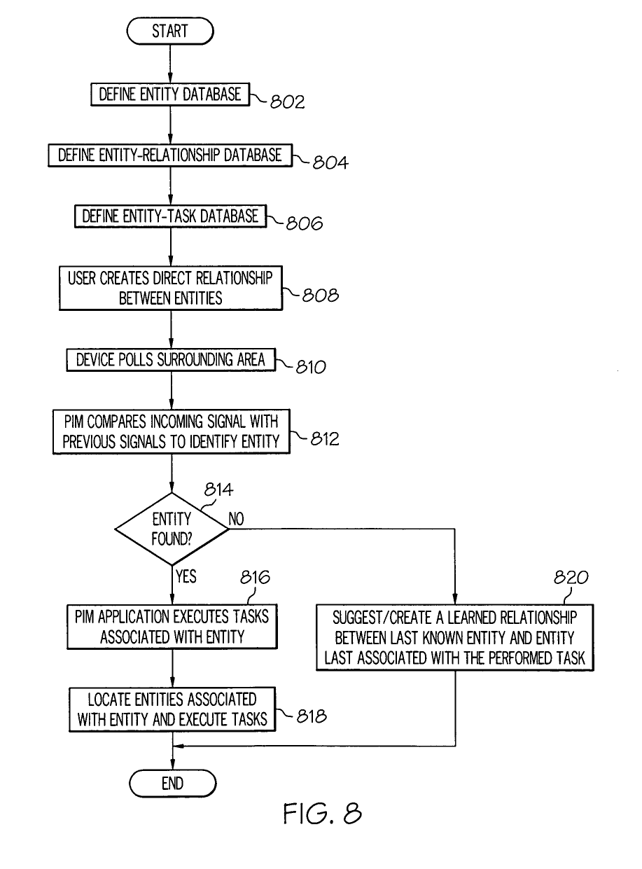

FIGS. 7A-C illustrates example entity relationships in accordance with an embodiment of the present invention. These known entity relationships may be stored in a mobile computing device, such as PDA 500 in FIG. 5.

In FIG. 7A, entity database 700 comprises a list of known entities. In this illustrative example, entity database 700 comprises entity names 702 and unique identifiers 704 associated with each entity. Entity information in entity database 700 may comprise user defined entities (e.g., from a private entity collection) and public entities (e.g., from a global database).

In FIG. 7B, entity-relationship database 706 comprises relationships between known entities in entity database 700. A user may create desired entity relationships stored on the mobile computing device. In addition, entity relationships may be created on the fly as the mobile computing device encounters new entities, and the user's activities indicate a desired relationship should be created. The user may refine the entity relationships between entities so that the entities fit the user's mental model. The personal information management software on the mobile computing device may also use these refined relationships to make task suggestions to the user.

In FIG. 7C, entity-task database 708 comprises associations between entities and tasks. Each task 710 is associated with at least one entity 712, and each entity may map to N tasks.

FIG. 8 is a flowchart of a process for exploiting entity relationships in a proximity-based task scheduler in accordance with an embodiment of the present invention. In particular, FIG. 8 provides an algorithm for creating, discovering, and reporting reminders using entity relationships. The process described in FIG. 8 may be implemented using a proximity-based task scheduler, such as personal information management software 412 in FIG. 4.

The process begins with defining an entity database as the union of a private entity collection and a global database of public entities (step 802). The entity database comprises a list of entities, each entity having a unique identifier. Next, the process defines an entity-relationship database as a set of equality and inclusion relationships between known entities (step 804). The process also defines an entity-task database, wherein the entity-task database comprises a list of tasks and associated entities, in the proximity of which the user is reminded to perform the tasks (step 806). Each entity in the entity-task database may map to N tasks, and each task may be associated with one or more entities. The entity database, entity-relationship database, and entity-task database may be located in the user's mobile computing device. For each entity that is created or discovered, the process receives user input to create a direct relationship with other entities (step 808). This step is similar to creating groups/folders.

Once the entities and relationships have been created, the user's mobile computing device may poll the surrounding area for RFID transmitter signals (step 810). When the mobile computing device receives a signal, such as one indicating that an entity is located, the personal information management software in the mobile computing device compares the incoming signal to previously recorded signals and the entity definitions associated with them (step 812). A determination is made as to whether an entity definition is found (step 814). If the entity definition is found, the personal information management software executes all of the tasks associated with that entity definition (step 816). The personal information management application may also query the entity-relationship database to locate other entities associated with the found entity, and execute their tasks as well (step 818).

Turning back to step 814, if the entity definition is not found, but the user still completes a task (not in the presence of the task's associated entity), the personal information management application may suggest and/or create a relationship between the last known entity and the one that was associated with the task (step 820). This learned relationship may be modeled as a suggestion to the user, or alternatively, the personal information management application may assume the relationship is correct and create the relationship. Once a relationship is learned in this manner, the personal information management software may use the relationship in the future to provide scheduling reminders to the user.

Thus, the present invention provides a calendaring application that accurately portrays the fluidity of a user's mental task scheduling by using entity relationships in a proximity-based task scheduler to model the “convenience” aspect of scheduling.

The description of the present invention has been presented for purposes of illustration and description, and is not intended to be exhaustive or limited to the invention in the form disclosed. Many modifications and variations will be apparent to those of ordinary skill in the art.

What is claimed is:

1. A method for using entity relationships to schedule execution of tasks in a data processing system, the method comprising
receiving a signal from an entity in proximity to a user of the data processing system;
comparing the signal against a plurality of previously recorded signals;
identifying the entity that generated the signal from an entity definition associated with a previously recorded signal in response to the signal matching a previously recorded signal in the plurality of previously recorded signals;
identifying other entities associated with the entity; and
providing a reminder to perform tasks associated with the entity and tasks associated with the other entities while the user is in proximity to the entity.

2. The method of claim 1, further comprising:
determining whether a task has been performed with an unassociated entity in response to the signal not matching a previously recorded signal in the plurality of previously recorded signals; and
suggesting to the user that an entity relationship between the entity associated with the performed task and the unassociated entity be created in response to determining that a task has been performed with an unassociated entity.

3. The method of claim 1, further comprising:
determining whether a task has been performed with an unassociated entity in response to the signal not matching a previously recorded signal in the plurality of previously recorded signals; and
automatically creating a relationship between the entity associated with the performed task and the unassociated entity in response to determining that a task has been performed with an unassociated entity.

4. The method of claim 1, wherein the entity is identified by querying an entity database, wherein the entity database comprises a private entity collection and a global database of public entities.

5. The method of claim 4, wherein entity relationships in the global database of public entities are synchronized with entity relationships created by different users based on a threshold.

6. The method of claim 5, wherein the threshold comprises a number of users who have created a same entity relationship and a number of tasks for which the users discovered a same entity-task relationship.

7. The method of claim 1, wherein other entities associated with the entity are identified by querying an entity-relationship database, and wherein the entity-relationship database comprises a set of equality and inclusion relationships between known entities.

8. The method of claim 1, wherein tasks associated with the entity are identified by querying an entity-task database, wherein the task-entity database comprises a set of tasks and associated entities.

9. The method of claim 1, wherein the signal is received using sense-and-respond technology.

10. The method of claim 9, wherein the sense-and-respond technology is radio frequency identification.

11. The method of claim 1, wherein the signal is received in response to polling an area surrounding the data processing system.

12. The method of claim 1, wherein the signal is received in response to monitoring an area surrounding the data processing system.

13. The method of claim 1, wherein the entity is one of a person, place, or an object.

14. A data processing system for using entity relationships to schedule execution of tasks, the data processing system comprising:
a plurality of entities, wherein the entities comprise transmission units for transmitting signals; and
a portable computing device, wherein the portable computing device comprises a receiving unit for receiving signals from the transmission units when the portable computing device is in proximity to the entities, and wherein the portable computing device comprises computer usable program code for identifying an entity transmitting a signal through a comparison of the signal to previously recorded signals, identifying other entities associated with the entity, and providing a reminder to perform tasks associated with the entity and tasks associated with the other entities while a user of the portable computing device is in proximity to the entity.

15. A computer program product comprising:
a computer usable medium having computer usable program code for using entity relationships to schedule execution of tasks, said computer program product comprising:
computer usable program code for receiving a signal from an entity in proximity to a user of the data processing system;
computer usable program code for comparing the signal against a plurality of previously recorded signals;
computer usable program code for identifying the entity that generated the incoming signal from an entity definition associated with the previously recorded signal if the signal matches a previously recorded signal in the plurality of previously recorded signals;
computer usable program code for identifying other entities associated with the entity; and
computer usable program code for providing a reminder to perform tasks associated with the entity and tasks associated with the other entities while the user is in proximity to the entity.

16. The computer program product of claim 15, further comprising:
computer usable program code for determining whether a task has been performed with an unassociated entity in response to the signal not matching a previously recorded signal in the plurality of previously recorded signals; and
computer usable program code for suggesting to the user that an entity relationship between the entity associated with the performed task and the unassociated entity be created in response to determining that a task has been performed with an unassociated entity.

17. The computer program product of claim 15, further comprising:
computer usable program code for determining whether a task has been performed with an unassociated entity in response to the signal not matching a previously recorded signal in the plurality of previously recorded signals; and
computer usable program code for automatically creating a relationship between the entity associated with the performed task and the unassociated entity in response to determining that a task has been performed with an unassociated entity.

18. The computer program product of claim 15, wherein the entity is identified by querying an entity database, wherein the entity database comprises a private entity collection and a global database of public entities.

19. The computer program product of claim 18, wherein entity relationships in the global database of public entities are synchronized with entity relationships created by different users based on a threshold, wherein the threshold comprises a number of users who have created a same entity relationship and a number of tasks for which the users discovered a same entity-task relationship.

20. The computer program product of claim 18, wherein other entities associated with the entity are identified by querying an entity-relationship database, wherein the entity-relationship database comprises a set of equality and inclusion relationships between known entities, wherein tasks associated with the entity are identified by querying an entity-task database, and wherein the task-entity database comprises a set of tasks and associated entities.
